(19) United States
(12) Patent Application Publication
(10) Pub. No.: US 2013/0339837 A1
(43) Pub. Date: Dec. 19, 2013

(54) Method for Generating Test Report and Computer System Thereof

(71) Applicant: WISTRON CORPORATION, New Taipei City (TW)

(72) Inventor: Emma X Ma, New Taipei City (TW)

(73) Assignee: WISTRON CORPORATION, New Taipei City (TW)

(21) Appl. No.: 13/659,927

(22) Filed: Oct. 25, 2012

(30) Foreign Application Priority Data
Jun. 19, 2012 (CN) 201210208521.7

(51) Int. Cl. G06F 17/21

(52) U.S. Cl. 715/226

(57) ABSTRACT

A method for generating a test report in a computer system is disclosed. The method includes displaying a plurality of icons on a monitor of the computer system, wherein each icon is corresponding to a machine type; displaying a list on the monitor when the computer system receives a first click signal corresponding to an icon among the plurality of icons, wherein the list includes a plurality of fields, and data corresponding to a characteristic of an electronic device of the machine type is filled in each field; displaying a report generating icon on the monitor; and generating the test report according to data in the plurality of fields of the list when the computer system receives a second click signal corresponding to the report generating icon.

### BACKGROUND OF THE INVENTION

1. Field of the Invention

The present invention relates to a method for generating a test report and a computer system thereof, and more particularly, to a method for generating a test report and a computer system thereof capable of saving time for a user to write the test report, and reducing an error rate of writing the test report, to improve working efficiency.

2. Description of the Prior Art

In recent years, more and more companies produce electronic products. Under a great amount of competition between those companies, requirements for quality of the products become higher, and a speed of product development also becomes a challenge for the companies. Therefore, how to produce high quality products in an efficient way becomes the most important issue for every company.

In the process of developing the products, a large number of tests are required for the sake of product quality and stability. Batch testing is a method for performing a large number of tests, and is capable of performing tests for a large number of samples efficiently. There are many required test items such as a temperature test, an anti-vibration test, an electrostatic discharge test, an over-current protection test, etc. In each test, a test report is provided for presenting the test results in written words or diagrams. Though test processes may be accomplished rapidly with the batch test, test reports still need to be written manually and it usually consumes a large amount of time. As can be seen, low production efficiency may always occur in the process of written the test reports.

Besides, if the contents of test reports are too complex, an error rate of hand-written test reports may increase. When a test report is provided to a customer, if the error rate is too high, the customer may return the report back to ask for correction of the errors or for a rewritten report. It may cost more time for correspondence with the customer. Therefore, there is a need for providing a method for automatically generating the test reports, to improve efficiency and accuracy of generating the test reports, and avoid a waste of time caused by high error rates of the hand-written reports.

### SUMMARY OF THE INVENTION

It is therefore an objective of the present invention to provide a method for generating a test report with a report generating icon in a computer system and the computer system thereof.

An embodiment of the invention discloses a method for generating a test report in a computer system. The method comprises displaying a plurality of icons on a monitor of the computer system, wherein each icon is corresponding to a machine type; displaying a list on the monitor when the computer system receives a first click signal corresponding to an icon among the plurality of icons, wherein the list comprises a plurality of fields, and data corresponding to a characteristic of an electronic device of the machine type is filled in each field; displaying a report generating icon on the monitor; and generating the test report according to data in the plurality of fields of the list when the computer system receives a second click signal corresponding to the report generating icon.

An embodiment of the invention further discloses a computer system. The computer system comprises a processor; a storage device, for storing a program instructing the processor to execute the following steps to generate a test report: displaying a plurality of icons on a monitor of the computer system, wherein each icon is corresponding to a machine type; displaying a list on the monitor when the computer system receives a first click signal corresponding to an icon among the plurality of icons, wherein the list comprises a plurality of fields, and data corresponding to a characteristic of an electronic device of the machine type is filled in each field; displaying a report generating icon on the monitor; and generating the test report according to data in the plurality of fields of the list when the computer system receives a second click signal corresponding to the report generating icon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the invention.

FIG. 2 is a schematic diagram of a screen view according to an embodiment of the invention.

FIG. 3 is a schematic diagram of a list according to an embodiment of the invention.

FIG. 4 is a schematic diagram of a test report generating process according to an embodiment of the invention.

### DETAILED DESCRIPTION

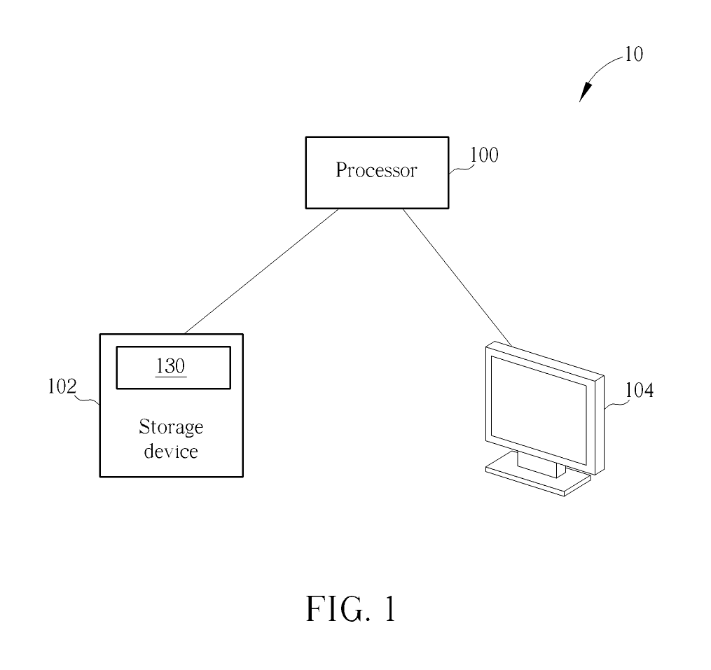

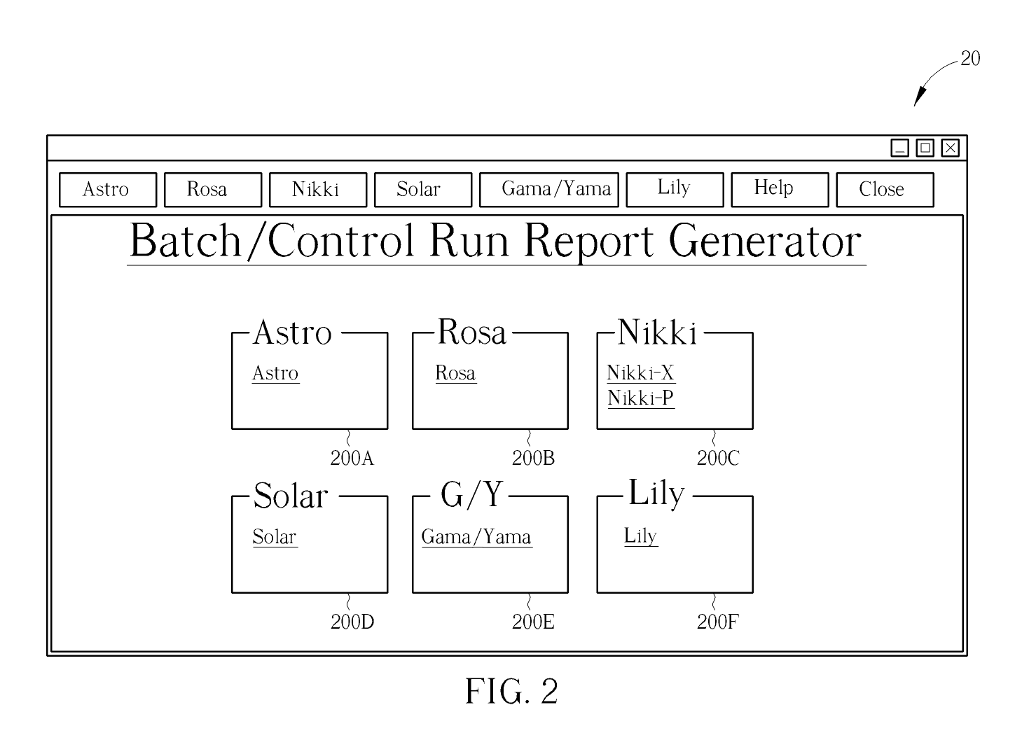

Please refer to FIG. 1, which is a schematic diagram of a computer system 10 according to an embodiment of the invention. As shown in FIG. 1, the computer system 10 includes a processor 100, a storage device 102, and a monitor 104. The storage device 102 is utilized for storing a program 130, which is utilized for instructing the processor 100 to execute each operation of the computer system 10. First of all, the processor 100 displays icons 200A˜200F on the monitor 104 of the computer system 10, as shown in FIG. 2, which is a schematic diagram of a screen view 20 according to an embodiment of the invention. The screen view 20 includes the icons 200A˜200F, each of which is corresponding to a machine type. A button is provided on each of the icons 200A˜200F, and a user can click the button to enter a page of a list according to the corresponding machine type to be tested. For example, if the machine type to be tested is Astro, the user may click the button corresponding to the machine type Astro to enter a page of a list corresponding to Astro.

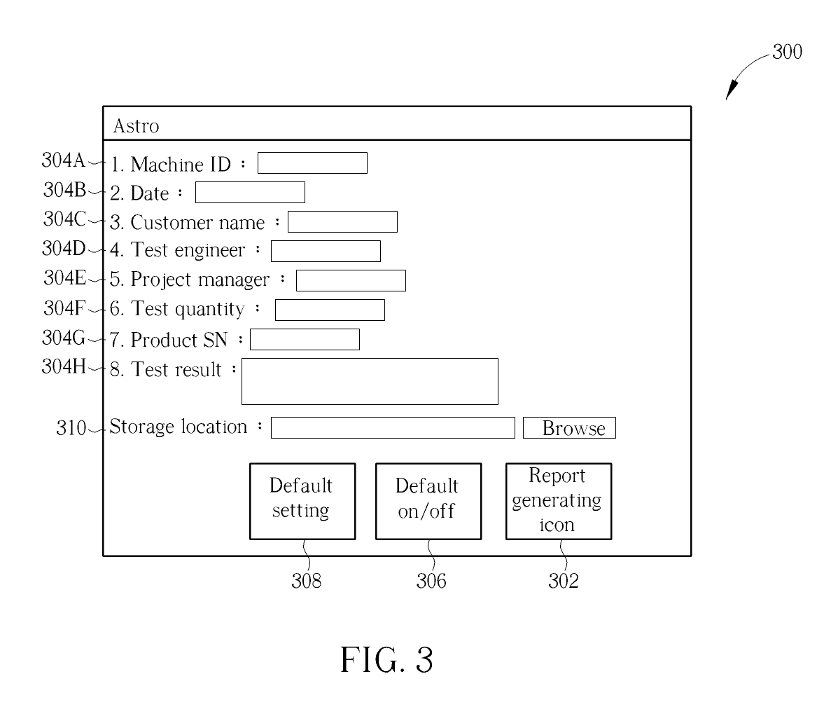

Please refer to FIG. 3, which is a schematic diagram of a list 300 according to an embodiment of the invention. The list 300 includes a report generating icon 302, fields 304A˜304H, a default optional button 306, a default setting button 308 and a storage location adjusting icon 310. The fields 304A˜304H can be filled in with information about general test reports, e.g. data corresponding to characteristics of an electronic device to be tested, such as machine type identification, test numbers, test dates, test results, and information about test engineers and customers, etc. Or, the fields 304A˜304H may also include a specific field for some machine type, and generate a specific data shown in a test report of the machine type. For example, a temperature-related machine type may show the highest and the lowest temperature in a test environment, or show that a test environment may comply with a temperature range of an industrial standard or a commercial standard. After the fields 304A˜304H are all filled in with data, the user can directly click the report generating icon 302 to generate the test report.

Please note that, as to each kind of test, if the same machine type is utilized, the structure of the generated report will also be the same. Therefore, each machine type may be corresponding to a list 300, and the test report generated by the same list 300 may also have the same structure. As a result, if a user needs to write a test report for some test, only the corresponding machine type needs to be determined, and the structure of the test report corresponding to the machine type can thus be obtained. Then, data filled in the list 300 can be filled as contents into a framework of the report, and the test report can thus be accomplished.

In addition, the contents in the fields 304A˜304H may be highly flexible. A user can flexibly adjust field numbers and the item of each field in the list 300 when maintaining the report generating system. In detail, though utilizing the same machine type, different customers may require different report contents. Therefore, the user may adjust the field contents in the list 300 according to requirements of different customers. Moreover, the list 300 further includes a default optional button 306. When the user clicks the default optional button 306 to initiate a default function, a default value may be filled in each of the fields 304A˜304H automatically to increase efficiency and convenience. For example, when a series of tests are performed for a product required by the same customer, the user can click the default setting button 308 to set the field 304C, i.e. customer name, to be the customer, and click to turn on the default optional button 306. As a result, each time when the list 300 is turned on, the field 304C will always be filled in with the default customer automatically. If the default data needs to be cancelled, the user may click the default optional button 306 once again to turn off the default function.

On the other hand, the present invention also provides a function for the user to select a storage location for the test report. The user can click a button of the storage location adjusting icon 310 to select a location in which the user needs to store the test report, or directly input a path of the location in which the user needs to store the test report in a path field. The test report may be stored in many kinds of formats in storage media such as a floppy disk, a hard disk drive, a memory card, an optical disk, a random access memory (RAM) and any other kinds of storage media. The user can select to use any one of the storage media and any one of the corresponding storage locations to store the test report.

Besides, a default format of the test report is a Word format, but the user can also flexibly select a desired report format to be generated. Common report formats include Word, PDF, Excel, TXT and other formats which can present the contents of the test report in written words or diagrams.

Please note that, the spirit of the present invention is to transfer a test result to a test report efficiently. Those skilled in the art can make modifications and alterations accordingly. For example, in order to improve efficiency and convenience, the present invention provides the function of the default optional button 306, and the user can click the default setting button 308 to set the field 304C (i.e. customer name) to be a specific customer. However, the method for setting a default value is not limited to the abovementioned one. In other embodiments, a pull down icon can also be utilized in each of the fields 304A˜304H for filling a default value, and is not limited herein. Besides, the fields and icons included in the list 300 shown in FIG. 3 are only one embodiment, and those skilled in the art can adjust the fields and icons included in the list 300 according to system requirements. Similarly, the icons 200A˜200F in FIG. 2 are related to different machine types, and those skilled in the art can properly adjust numbers, contents, names, etc. of the icons according to products classification, and is not limited herein. Such adjustments of contents of the icons 200A˜200F or the list 300 according to system requirements should be well-known for those skilled in the art, and will not be narrated hereinafter.

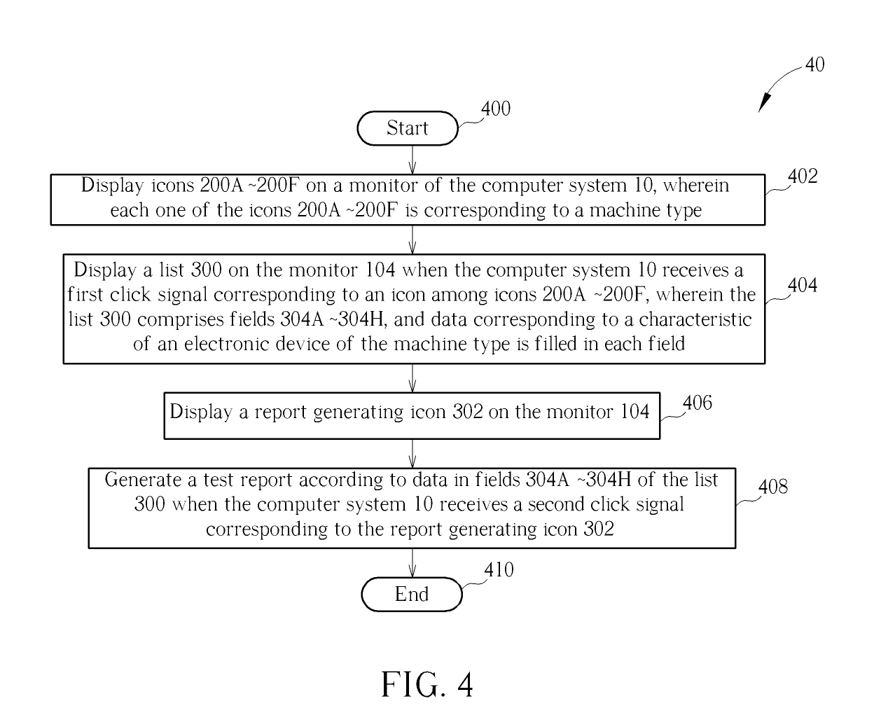

The abovementioned operation of the program 130 can be summarized into a test report generating process 40, as shown in FIG. 4. The test report generating process 40 includes the following Steps :

Step 400: Start.

Step 402: Display icons 200A˜200F on a monitor of the computer system 10, wherein each one of the icons 200A˜200F is corresponding to a machine type.

Step 404: Display a list 300 on the monitor 104 when the computer system 10 receives a first click signal corresponding to an icon among icons 200A˜200F, wherein the list 300 comprises fields 304A˜304H, and data corresponding to a characteristic of an electronic device of the machine type is filled in each field.

Step 406: Display a report generating icon 302 on the monitor 104.

Step 408: Generate a test report according to data in fields 304A˜304H of the list 300 when the computer system 10 receives a second click signal corresponding to the report generating icon 302.

Step 410: End.

The detailed operations and alternations of the test report generating process 40 can be referred to the above description, and will not be narrated hereinafter.

In the prior art, hand-written test reports consume a lot of time, and if the contents of the test reports are too complex, the error rate of the hand-written test reports may increase. In comparison, the present invention provides a method for generating test reports automatically, which is capable of saving time for a user to write the test reports, and reducing an error rate of writing the test reports, to improve working efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating a test report in a computer system, the method comprising:
displaying a plurality of icons on a monitor of the computer system, wherein each icon is corresponding to a machine type;
displaying a list on the monitor when the computer system receives a first click signal corresponding to an icon among the plurality of icons, wherein the list comprises a plurality of fields, and data corresponding to a characteristic of an electronic device of the machine type is filled in each field;
displaying a report generating icon on the monitor; and
generating the test report according to data in the plurality of fields of the list when the computer system receives a second click signal corresponding to the report generating icon.

2. The method of claim 1, wherein the data filled in the plurality of fields comprise machine type identification, test numbers, test dates and test results.

3. The method of claim 1, further comprising adjusting field numbers and contents of the list according to a user command.

4. The method of claim 1, wherein at least one field among the plurality of fields comprises a pull down icon, which comprises at least one default icon.

5. The method of claim 1, further comprising storing the test report in a storage device of the computer system.

6. The method of claim 5, further comprising displaying a storage location adjusting icon on the monitor for modifying a storage location of the storage device in which the test report is stored when the computer system receives a third click signal corresponding to the storage location adjusting icon.

7. A computer system, comprising:
a processor;
a storage device, for storing a program instructing the processor to execute the following steps to generate a test report:
displaying a plurality of icons on a monitor of the computer system, wherein each icon is corresponding to a machine type;
displaying a list on the monitor when the computer system receives a first click signal corresponding to an icon among the plurality of icons, wherein the list comprises a plurality of fields, and data corresponding to a characteristic of an electronic device of the machine type is filled in each field;
displaying a report generating icon on the monitor; and
generating the test report according to data in the plurality of fields of the list when the computer system receives a second click signal corresponding to the report generating icon.

8. The computer system of claim 7, wherein the data filled in the plurality of fields comprise machine type identification, test numbers, test dates and test results.

9. The computer system of claim 7, wherein the program further instructs the processor to adjust field numbers and contents of the list according to a user command.

10. The computer system of claim 7, wherein at least one field among the plurality of fields comprises a pull down icon, which comprises at least one default icon.

11. The computer system of claim 7, wherein the program further instructs the processor to store the test report in a storage device of the computer system.

12. The computer system of claim 11, wherein the program further instructs the processor to display a storage location adjusting icon on the monitor for modifying a storage location of the storage device in which the test report is stored when the computer system receives a third click signal corresponding to the storage location adjusting icon.
